(19) United States
(12) Patent Application Publication
(10) Pub. No.: US 2025/0026236 A1
(43) Pub. Date: Jan. 23, 2025

(54) SELECTIVE VEHICLE SENSOR ACTUATION

(71) Applicant: Ford Global Technologies, LLC, Dearborn, MI (US)

(72) Inventors: Stuart C. Salter, White Lake, MI (US); Candice Villanueva, West Bloomfield, MI (US); Brendan Francis Diamond, Grosse Pointe, MI (US); Darnell Fuller, Detroit, MI (US); Mark Viergutz, Canton, MI (US); Sivaram Sudhakar Dogiparthi, Westland, MI (US)

(73) Assignee: Ford Global Technologies, LLC, Dearborn, MI (US)

(21) Appl. No.: 18/353,975

(22) Filed: Jul. 18, 2023

(51) Int. Cl. B60L 58/12; B60L 1/00

(52) U.S. Cl. CPC B60L 58/12; B60L 1/00; B60L 2240/60

(57) ABSTRACT

A system can include a computer coupled to a memory storing instructions to determine an upcoming interval for operating a sensor at a planned destination and to determine an upcoming duration for travel to the planned destination. In response to determining that a battery coupled to the sensor includes a state-of-charge (SOC) that is insufficient to operate the sensor for the upcoming interval, programming of the computer can schedule a charge interval during vehicle travel to the planned destination and actuate the battery charging according to the scheduled charge interval during the vehicle travel.

### BACKGROUND

Vehicles can be equipped with computing devices, networks, sensors, and controllers to acquire data regarding the vehicle's environment and to operate the vehicle based on the data. Sensors can provide data to detect features of the environment, such as markings on a road or other travel surface, road signs, objects, such as other vehicles or obstacles such as rocks or debris, etc. Sensor data can be provided over a vehicle network to one or more controllers or other computers on the vehicle network. Vehicle sensors can thus provide data as a vehicle travels to a destination, e.g., to determine a route or possible routes to the destination. Sensors can additionally or alternatively be used to provide data about an environment around a vehicle when the vehicle is deactivated and/or not moving.

### BRIEF DESCRIPTION OF THE DRAWINGS

FIG. 1 is a block diagram of an example vehicle system.

FIG. 2 is a graph showing an operating window of internal combustion engine parameters of a vehicle.

FIG. 3 is an illustration of an example display of a vehicle system showing a route to a planned destination.

FIGS. 4A and 4B are block diagrams of example processes for vehicle sensor operation.

### DETAILED DESCRIPTION

To detect objects in areas external to a vehicle while the vehicle is deactivated, such as while the vehicle is parked at a location, the vehicle can include a set of sensors and/or processing resources for monitoring the external areas. The sensors can monitor the vehicle and/or an environment around the vehicle, e.g., in an exposed truck bed, on walkways near the vehicle, in parking lots, etc. Since such sensors are actuated while the vehicle is deactivated, sensors for monitoring areas external to the vehicle may include an additional sensor battery separate from the main vehicle battery. Thus, the sensor battery can be relied upon to provide power for the sensors while the vehicle is deactivated. A deactivation period can last for minutes, hours, days, or longer.

To maintain sufficient state-of-charge (SOC) of a sensor battery to power the sensors while a vehicle is in a deactivated and/or unattended state, a computer in the vehicle can actuate the propulsion and/or the main vehicle battery to recharge the sensor battery while the vehicle is in operation, e.g., traveling along a route to a destination. The computer can determine a specified amount of charge for the sensor battery, which may power the sensors for a specified interval during which the vehicle may be deactivated. The computer can determine a recharge rate, i.e., a current supplied by a propulsion component (via an alternator or the like) and/or the vehicle battery to restore a charge level of the sensor battery to the specified amount of charge upon or prior to completion of the route traveled by the vehicle. The computer can thus, while traveling along a route to a planned destination location prior to vehicle deactivation, charge the sensor battery so that the battery is available to power the sensors while the vehicle is deactivated for the specified interval.

In some instances, however, a planned destination at which a vehicle is to be deactivated may include a location at which monitoring an area external to the vehicle is not likely to be activated, or, perhaps, activated for only a short period of time. For example, if a planned destination includes a secured garage at a private home, it may be unnecessary to actuate a sensor to monitor areas external to the vehicle. In such an example, where a sensor battery likely will not be utilized at the planned destination, charging the sensor battery in advance of arriving at the planned destination may represent an inefficient use of vehicle propulsion resources. In another example, if a planned destination includes a convenience store or other establishment that a vehicle may visit for a short period of time, fully charging a sensor battery may, again, represent an inefficient use of vehicle propulsion resources. In another example, in response to determining that a vehicle sensor battery does not include sufficient SOC to operate a sensor for a specified upcoming interval, it may be useful to actuate charging of the sensor battery while the vehicle engine is operating at higher efficiency and to refrain from actuating charging while the vehicle engine is operating at a lower efficiency.

An example system for vehicle sensor operation can include a computer including a processor coupled to a memory, the memory storing instructions executable by the processor to determine an upcoming interval for operating a sensor at a planned destination and to determine an upcoming duration for travel to the planned destination. In response to determining that a battery coupled to the sensor includes a state-of-charge (SOC) insufficient to operate the sensor for the upcoming interval, schedule a charge interval during vehicle travel to the planned destination the instructions may additionally be to actuate the battery charging according to the scheduled charge interval during the vehicle travel.

The upcoming interval can be based on a risk parameter at the planned destination.

The upcoming interval can include an increased value based on the risk parameter at the planned destination being greater than a threshold value.

The upcoming interval can be decreased based on the risk parameter at the planned destination being less than a threshold value.

The vehicle travel to the planned destination can be segmented. In addition, the scheduled charge interval is distributed among the segments.

The scheduled charge interval can indicate battery charging exclusively at a segment during which an engine of the vehicle is predicted to operate with greater than a threshold efficiency.

The instructions can further include instructions to evaluate a historical pattern of vehicle travel between a current location of the vehicle and the planned destination to predict the SOC.

The historical pattern of travel between the current location and the planned destination can include a time of day or during a day of the week.

The instructions can further include instructions to actuate a component of a human-machine interface responsive to deactivation of the vehicle at the planned destination, wherein the component indicates that the sensor is to be operated at the planned destination.

The instructions further include instructions to actuate the battery charging operation responsive to an engine of the vehicle attaining greater than a threshold fuel efficiency.

The instructions further include instructions to actuate the battery charging operation responsive to an engine of the vehicle attaining a brake specific fuel consumption that is less than a threshold value.

The instructions to actuate the battery charging operation can include instructions to actuate the battery charging operation during any operation of an engine of the vehicle responsive to the determination that the battery charging operation is predicted to result in an insufficient SOC.

The sensor can include a camera to view a portion of an environment external to the system.

An example method for vehicle sensor operation can include determining an upcoming interval for operating the sensor at a planned destination and determining an upcoming duration for travel to the planned destination. The method can additionally include, responsive to determining that a battery coupled to the sensor includes an SOC that is insufficient to operate the sensor for the upcoming interval, scheduling a charge interval during vehicle travel to the planned destination. The method can additionally include actuating the battery charging according to the scheduled charge interval during the vehicle travel.

The method can additionally include determining a risk parameter at the planned destination and determining the upcoming interval based on the risk parameter.

The vehicle travel to the planned destination can be divided into travel segments, and the method can additionally include distributing the scheduled charge interval among the travel segments.

The method can additionally include determining a historical pattern of vehicle travel between a current location of the vehicle and the planned destination.

The method can additionally include actuating the battery charging operation responsive to an engine of the vehicle attaining a brake specific fuel consumption that is less than a threshold value.

The sensor can be a camera to view a portion of an environment external to the vehicle.

Actuating the battery charging operation can include actuating the battery charging operation during any operation of an engine of the vehicle responsive to the determining that the battery charging operation of the battery is predicted to result in an insufficient state of charge.

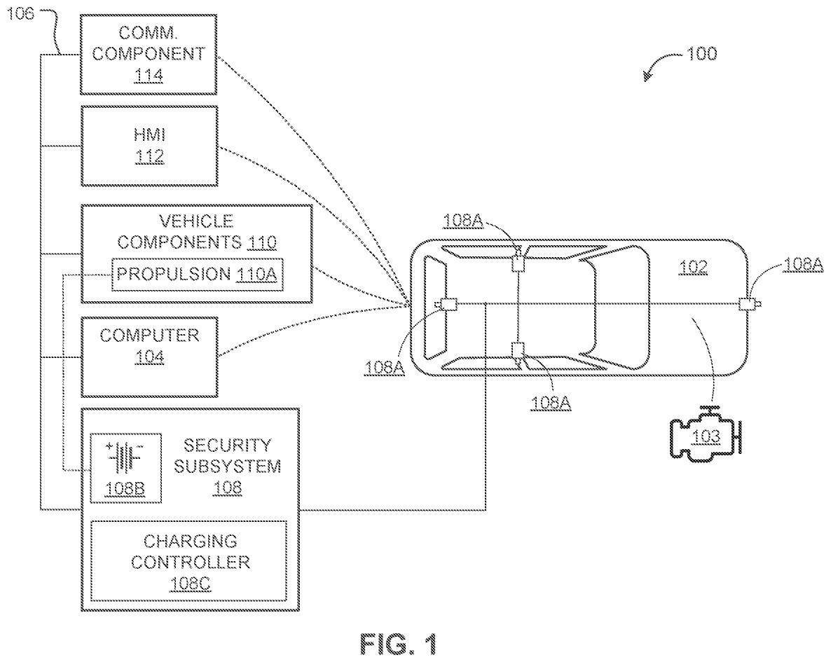

FIG. 1 illustrates an example system 100 for operating sensors of vehicle 102. Computer 104 of vehicle 102 can be programmed to receive signals representing data output from various sensors, including sensors 108A. In an example, output signals from sensors 108A may include data relating to a relative location of vehicle 102, data relating to an environment around a vehicle, data relating to a static or moving object outside the vehicle, such as another vehicle, an individual within the field of view of one or more of sensors 108A, etc. Thus, sensors 108A may provide images of static or moving objects during various vehicle operations, such as detection and recognition of vehicles located in the environment external to vehicle 102 as the vehicle proceeds along a roadway. In the example of FIG. 1, sensors 108A may additionally provide data to security subsystem 108, which may operate as an integrated security controller for monitoring moving or static objects within a field of view of one or more of sensors 108A. Sensors 108A may include still or video cameras for observing areas external to vehicle 102. In the example of FIG. 1, sensors 108A can be positioned to observe static or moving objects located in a forward direction with respect to vehicle 102, in a rearward direction with respect to vehicle 102, and/or to the left and right sides of vehicle 102. Thus, in the example of FIG. 1, output data from sensors may be combined to form a panoramic video or still image in any direction with respect to vehicle 102. Accordingly, after deactivating vehicle 102, security subsystem 108 can monitor activity of static or moving objects for which a change of state could, for example, represent intentional or unintentional damage of vehicle 102, a vehicle break-in, removal or theft of items stored in one or more compartments of the vehicle, or activities related to theft of vehicle 102. Although the example of FIG. 1 indicates vehicle 102 having four of sensors 108A, in other examples, vehicle 102 can include a different number of sensors 108A, such as a single omnidirectional sensor, two hemispherical sensors, or any other number of sensors (e.g., 3, 5, 6, 8, etc.).

Vehicle 102 can include sensors other than sensors 108A, such as sensors for monitoring and detecting aspects of the vehicle's driving environment. Such sensors can include short-range radar sensors, long-range radar, LIDAR sensors, ultrasonic transducers, motion detectors, etc. Further, vehicle 102 can include sensors for measuring internal vehicle states and modes, such as a sensor to measure engine speed (in revolutions per minute) such as a tachometer, wheel speed sensors, tire pressure sensors, etc. Sensors of vehicle 102 can further include sensors for measuring torque e.g., a calibrated strain gauge, applied by engine 103 to the driveshaft of vehicle 102.

Security subsystem 108 can include sensor battery 108B, which may be allocated to provide power for actuating sensors 108A. In response to propulsion component 110A and/or the main battery of vehicle 102 being deactivated, security subsystem 108 can draw operating power from the sensor battery 108B. Sensor battery 108B can operate sensors 108A until the user reactivates vehicle 102, or until the sensor battery is exhausted. Sensor battery 108B can be controlled by charging controller 108C, which can operate to determine the SOC of the sensor battery, transmit the SOC to computer 104, determine a remaining time interval during which sensors 108A can be operated, and transmit the remaining time to computer 104. In an example, charging controller 108C may utilize a voltage sensor to sense voltage output of sensor battery 108B. In an example implementation, as the SOC of sensor battery 108B declines, the voltage at an output terminal of the sensor battery may also decline. Charging controller 108C can register the decline in battery voltage and, via a lookup table stored in a memory of the controller and/or via a computer algorithm, determine the remaining capacity of sensor battery 108B. Sensor battery 108B can include any suitable battery technology, such as, for example, lithium-ion. Sensor battery 108B can provide power to one or more of sensors 108A while the vehicle is deactivated and/or unattended, as described below.

Computer 104 can be generally programmed for communications on a vehicle network 106, which may include a communications bus such as a CAN bus, LIN bus, etc., and/or other wired and/or wireless technologies, e.g., Ethernet, WIFI, Bluetooth®, Ultra-Wideband (UWB), etc. Vehicle network 106 can represent one or more mechanisms by which computer 104 may communicate with a remote computer, such as a remote server. Accordingly, vehicle network 106 can include one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), UWB, IEEE 802.11, vehicle-to-vehicle (V2V) such as Dedicated Short-Range Communications (DSRC), etc.), local area networks (LAN) and/or wide area networks (WAN), including the Internet, providing data communication services.

Alternatively or additionally, in examples in which computer 104 includes multiple devices, vehicle network 106 can be used for communications between devices represented as computer 104. In an example, computer 104 can be a generic computer with a processor and memory as described above and/or may include an electronic control unit (ECU) or controller or the like for a specific function or set of functions, and/or a dedicated electronic circuit including an ASIC that is manufactured for a particular operation, e.g., an ASIC for processing sensor data and/or communicating the sensor data. In another example, computer 104 may include an FPGA (Field-Programmable Gate Array) which is an integrated circuit manufactured to be configurable by an authorized user. Typically, a hardware description language such as VHDL (Very-High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in computer 104. In addition, computer 104 may be programmed for communicating with communications component 114, human-machine interface (HMI) 112, and vehicle components utilizing vehicle network 106, which, as described below, may include various wired and/or wireless networking technologies, e.g., cellular, Bluetooth®, Bluetooth® Low Energy (BLE), UWB, wired and/or wireless packet networks, etc.

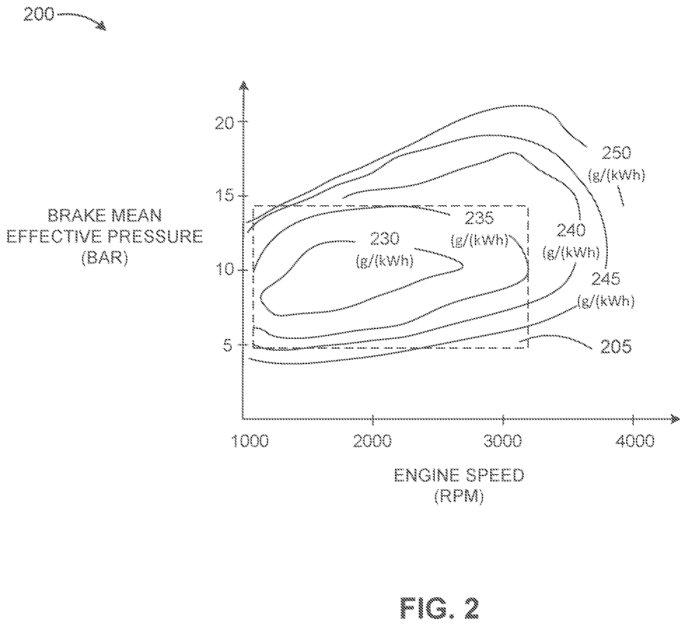

Vehicle 102 can include a variety of additional devices, such as vehicle components 110, which may utilize vehicle network 106 to transmit and receive, for example, data relating to vehicle speed, acceleration, location, subsystem and/or component status, etc. In an example, additional sensors of vehicle 102 can provide data for controlling operation of a component of a set of vehicle components 110, such as a component for controlling an aspect of vehicle operation. Thus, as seen in FIG. 1, vehicle components 110 can include components to evaluate operation of propulsion component 110A. In an example, computer 104, in response to receiving output data from charging controller 108C, can determine a “charge level,” i.e., an amount of electricity that sensor battery 108B can provide to sensors 108A, measured in amp-hours (Ah). Computer 104 can evaluate parameters of engine 103 of vehicle 102 and control whether propulsion component 110A is to actuate charging of sensor battery 108B of security subsystem 108, e.g., via an alternator of vehicle 102. In an example, computer 104 may actuate charging of sensor battery 108B exclusively while engine 103 is operating at greater than a threshold efficiency, e.g., at a brake specific fuel consumption of less than 235 grams of fuel consumed per kilowatt hour, as described in greater detail in reference to FIG. 2.

Vehicle components 110 can include other hardware entities adapted to perform a mechanical or electromechanical function or operation, such as moving vehicle 102, slowing or stopping the vehicle, steering the vehicle, etc. Vehicle components 110 can include transmission components, steering components, (which may include one or more of a steering wheel, a steering rack, etc.), a brake component, a park assist component, an adaptive cruise control component, an adaptive steering component, a movable seat, and the like. Vehicle components 110 can further include computing devices, e.g., electronic control units (ECUs) or the like and/or computing devices such as described above with respect to computer 104, and that likewise communicate via vehicle network 106.

### Exemplary System Operations

In an example implementation, security subsystem 108 may be scheduled to operate at a planned destination for a specified upcoming interval. In the context of this disclosure, an “upcoming interval” means a predicted interval during which a sensor is to be operated while a vehicle, e.g., vehicle 102, is planned or foreseen as being deactivated, not moving, and unattended by an operator. Thus, an upcoming interval can include a period of minutes, hours, or days during which the vehicle is predicted to be at rest, unattended, and deactivated. The upcoming interval can be determined in accordance with a risk parameter at the planned destination. In the context of this disclosure, a “risk parameter” means a computed, derived, or assigned a probability of theft to a vehicle, a vehicle break-in, damage to a vehicle, or unauthorized removal of items from the vehicle. For example, a digital map may include identifiers that assign a level of risk to certain areas of a city based on the rate of occurrence of vehicle break-ins, theft, vandalism etc., in such areas. Thus, for parking on a particular portion of a city street, the digital map may assign a relatively high risk parameter in response to a high rate of reported vehicle break-ins, theft, vandalism, etc., in the area and assign a relatively low risk parameter in response to a low rate of break-ins, theft, vandalism, etc., reported in the area. In another example, programming of computer 104 may determine a risk parameter, which may determine that any city street parking is to be assigned a relatively high risk parameter and that parking in a locked and monitored garage is to be assigned a relatively low risk parameter. A risk parameter can be expressed using any convenient scale. In some examples, a risk parameter may be expressed as a value of between 0.01 and 1.00, which may indicate a probability of vehicle theft, vehicle damage, vehicle break-in, etc., at a planned destination.

In an example, programming of computer 104 may assign an upcoming interval for operation of sensors 108A in response to a determined, assigned, and/or computed risk parameter, which may utilize variables, constants, and/or program steps stored in a memory accessible to computer 104. For example, for a determined, assigned, and/or computed risk parameter of less than 0.01, programming of computer 104 can assign an SOC of sensor battery 108B to permit operation of sensors 108A for an upcoming interval of less than or equal to 1.0 hours. In another example, for a determined, assigned, and/or computed risk parameter of between 0.02 and 0.03, computer 104 can assign an SOC of sensor battery 108B to permit operation of sensors 108A for an upcoming interval of between 1.0 hours and 2.5 hours. In another example, for a determined, assigned, and/or computed risk parameter of greater than 0.04, computer 104 can assign an SOC of sensor battery 108B to permit operation of sensors 108A for an extended upcoming interval, such as an upcoming interval greater than 24 hours or until sensor battery 108B has been fully depleted.

In response to determination of the risk parameter at the planned destination, programming of computer 104 may actuate charging of sensor battery 108B to provide sufficient battery power exclusively for the upcoming interval, and without providing excess battery charging for utilizing the battery 108B outside of the interval. Accordingly, as described in reference to FIG. 2, programming of computer 104 may instruct propulsion component 110A to selectively actuate (e.g., responsive to engine 103 attaining lower threshold of brake specific fuel consumption, such as greater than 235 grams of fuel consumed per kilowatt hour) charging of sensor battery 108B during travel to the planned destination. Programming of computer 104 may instruct propulsion component 110A to deactivate charging of sensor battery 108B in response to the sensor battery reaching an SOC that is capable of providing sufficient battery power. Such deactivation can permit engine 103 to operate with increased efficiency, e.g., without unwarranted excess charging of sensor battery 108B. Such selective charging of sensor battery 108B may additionally prolong the life of the sensor battery by refraining from overcharging the sensor battery.

FIG. 2 is a graph 200 showing an operating window of example internal combustion engine parameters of vehicle 102. Internal combustion engine parameters can include an engine speed parameter and a parameter of brake mean effective pressure. As shown in the example of FIG. 2, programming of computer 104 may selectively actuate charging of sensor battery 108B in response to an engine speed parameter, measured by an engine speed sensor, e.g., a tachometer, being within a specified range. In addition, programming of computer 104 may utilize output data from a torque sensor to compute brake mean effective pressure in accordance with equation (1) below:

$$Brake Mean Effective Pressure = \frac{2 π n T}{D} \qquad ( 1 )$$

wherein n=2 for a four-stroke engine. T represents torque measured by a torque sensor positioned on the driveshaft of vehicle 102, and wherein D represents the displacement of engine 103. Alternatively or in addition, programming of computer 104 may utilize a lookup table stored in memory that maps torque measured by a torque sensor positioned on the driveshaft of vehicle 102 to derive brake mean effective pressure from torque measurements.

As seen in FIG. 2, within certain ranges of brake mean effective pressure and the speed of engine 103, e.g., as indicated by performance window 205, sensor battery 108B can be charged with greater efficiency than at ranges of brake mean effective pressure and the speed of engine 103 that are outside of performance window 205. In the context of this disclosure, a “performance window” means one or more ranges of parameters of a system, within which a specified outcome can be achieved. As an example, performance window 205 identifies a range of the speed of engine 103 (in RPM) and brake mean effective pressure, within which engine 103 attains a nominal value of brake specific fuel consumption. In this context, “brake specific fuel consumption” means a ratio of a quantity of fuel consumed by an engine to an amount of rotational power produced by the engine. Accordingly, brake specific fuel consumption can be a measure of the mechanical efficiency of engine 103. Thus, lower numbers of brake specific fuel consumption indicate that a low amount of consumed fuel produces a specified amount of usable power (e.g., one kilowatt hour) by engine 103.

Consequently, charging of sensor battery 108B at lower values of brake specific fuel consumption may be advantageous in that such lower values represent lower fuel consumption per unit of usable power produced by engine 103. It is noted that the engine parameters depicted in FIG. 2 relate to an exemplary internal combustion engine and that numerous variations in relationships among engine speed, brake mean effective pressure, and brake specific fuel consumption are possible. Thus, for internal combustion engines configured differently from engine 103 (e.g., including engines used in hybrid vehicles, gasoline or diesel engines, engines utilizing liquefied natural gas, etc.), engine speed, brake mean effective pressure, and brake specific fuel consumption may vary widely from the example of FIG. 2. However, despite various possible configurations of internal combustion engines, it can be advantageous to actuate charging of a sensor battery (e.g., sensor battery 108B) in response to the internal combustion engine attaining a decreased value of brake specific fuel consumption or other parameter that indicates a measure of increased mechanical efficiency of the internal combustion engine.

In FIG. 2, the horizontal axis represents engine speed of vehicle 102, as measured in revolutions per minute (RPM) at the crankshaft of engine 103 of vehicle 102. The vertical axis of FIG. 2 represents the brake mean effective pressure, measured in bars, which signifies an average pressure inside of a cylinder as engine 103 operates within vehicle 102. The contoured lines of FIG. 2 represent brake specific fuel consumption as measured in grams of fuel consumed per kilowatt-hour (g/kWh). Thus, from FIG. 2, it can be seen that brake specific fuel consumption attains a relatively low value, e.g., 230 g/kWh, responsive to engine 103 attaining a brake mean effective pressure of between approximately 7 bars and 11.5 bars and an engine RPM of between approximately 1000 and 2800. Accordingly, in an example, programming of computer 104 may actuate charging of sensor battery 108B exclusively in response to engine 103 attaining a specified threshold fuel efficiency (e.g., less than 250 grams g/kWh) in accordance with the values described above. Additionally, in an example, programming of computer 104 may refrain from actuating charging of sensor battery 108B responsive to engine 103 operating outside of the above values, such as during travel segments that may involve engine 103 idling vehicle 102 as the vehicle proceeds slowly through city traffic. In the context of this disclosure, a “segment” means any subdivision of a travel route. Thus, for example, a travel route may include a city segment, which may be characterized by predominantly stop-and-go traffic at low vehicle speeds. A travel route may also include a highway segment, which may be characterized by a predominantly constant speed with few vehicle stops. Via selective actuation of charging of sensor battery 108B, such as exclusively during a highway segment of a route, programming of computer 104 can bring about increased efficiency in the conversion of fuel consumed by engine 103 to energy stored by sensor battery 108B.

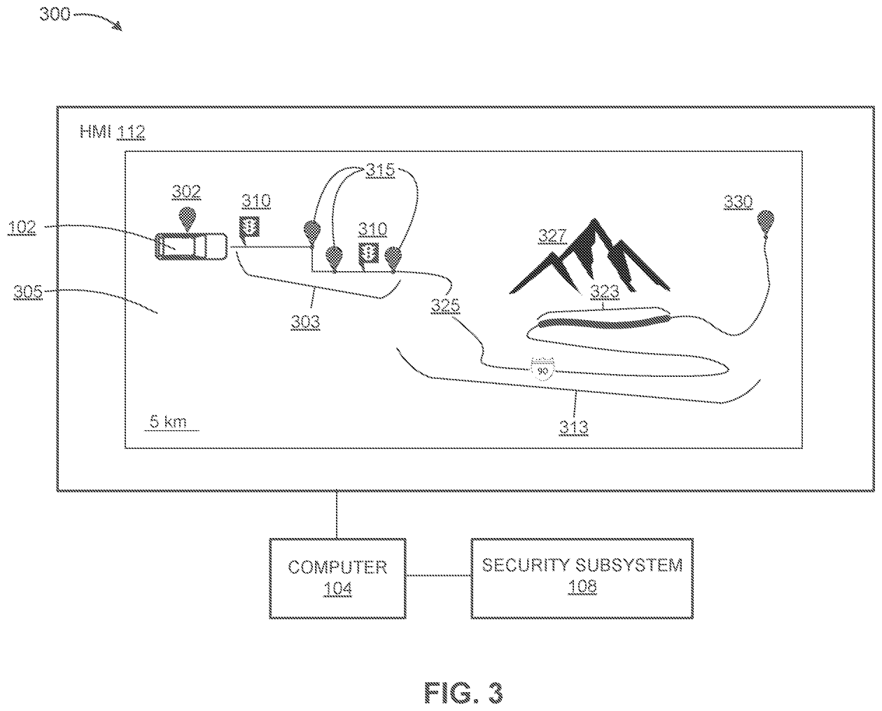

FIG. 3 is an illustration of an example display of a vehicle system 300 showing a route to a planned destination. In FIG. 3, vehicle 102 is indicated as traveling along the route to planned destination 330. At planned destination 330, vehicle 102 may be deactivated and security subsystem 108 can operate to monitor areas external to the vehicle during an upcoming interval. The planned route can be displayed utilizing display 305, which can be a display component of vehicle HMI 112. Programming of computer 104 can actuate display of the planned route responsive to an operator of vehicle 102 interacting with HMI 112 to provide turn-by-turn directions for travel to intermediate destinations 315 and to planned destination 330. In an example, intermediate destinations 315 may include fuel stations, convenience stores, fast food establishments, beverage kiosks, etc., which may be spaced at relatively short distances from each other. Thus, travel to intermediate destinations 315 can represent stop-and-go segment 303 of vehicle travel to planned destination 330. After visiting intermediate destinations 315, vehicle 102 may be scheduled to proceed along highway 325 toward mountains 327 before reaching planned destination 330. In FIG. 3, travel along highway 325 is indicated as highway segment 313 of vehicle travel to planned destination 330.

At current location 302, programming of charging controller 108C may report an SOC of sensor battery 108B that is insufficient to operate sensors 108A for an upcoming interval while the vehicle is deactivated and left unattended at planned destination 330. Hence, as described in reference to FIG. 2, programming of computer 104 may schedule a charge interval of sensor battery 108B exclusively during certain ranges of brake mean effective pressure and speed of engine 103 of vehicle 102. In the context of this disclosure, a “charge interval” means a time period, during vehicle travel while engine 103 is propelling vehicle 102 or while engine 103 is idling, when computer 104 actuates propulsion component 110A to execute or perform a charge operation to charge sensor battery 108B. Thus, for example, during vehicle travel, computer 104 may actuate a propulsion component to engage an alternator, or to actuate a control component of an alternator, to initiate current conduction from the alternator to sensor battery 108B. In an example, a charge interval can occur during some or all segments of vehicle travel to planned destination 330. Accordingly, since upcoming vehicle travel to intermediate destinations 315 involves stop-and-go segment 303, during which engine 103 may be idling or proceeding slowly through city traffic, e.g., as indicated by stoplights 310, programming of computer 104 may schedule an interval for charging sensor battery 108B outside of such segments. In addition, since upcoming vehicle travel includes use of highway 325, programming of computer 104 may schedule propulsion component 110A to charge sensor battery 108B to occur during highway segment 313. During such highway travel, the speed and output torque of engine 103 of vehicle 102 may operate at ranges of brake mean effective pressure and speed that result in increased efficiency in charging sensor battery 108B.

As described in reference to FIG. 1, an upcoming interval for operating a sensor at a planned destination, e.g., planned destination 330, can be determined based on a risk parameter at the planned destination. Accordingly, in an example for which planned destination 330 represents a destination at which a risk parameter is less than a threshold value, e.g., less than 0.03, less than 0.04, etc., programming of computer 104 may determine or assign an upcoming interval for operation of sensor 108A that is relatively short in duration. Thus, programming of computer 104 may actuate charging of sensor 108A for a relatively short charge interval, such as 15 minutes, 30 minutes, etc., so as to bring the SOC to a sufficient level for operation over the upcoming interval. Consequently, programming of computer 104 may schedule a relatively small charge interval (e.g., charge interval 323) during travel of vehicle 102 to destination 330. Further, programming of computer 104 may schedule charge interval 323 to occur exclusively during travel along highway segment 313 (e.g., a highway segment). In such an example, computer 104 can actuate propulsion component 110A to charge sensor battery 108B until the sensor battery attains sufficient SOC to operate exclusively over the upcoming interval and then deactivate charging after the sufficient SOC has been attained.

In another example, in response to planned destination 330 representing a destination at which a risk parameter exceeds a first threshold value, e.g., 0.05, 0.06, etc., programming of computer 104 may determine or assign an upcoming interval for operation of sensor 108A that is relatively long in duration. Thus, to bring the SOC of sensor battery 108B to a sufficient level, computer 104 can actuate charging of sensor 108A for a relatively long interval, such as one hour, two hours, etc. Consequently, programming of computer 104 may schedule a relatively long charge interval during travel of vehicle 102 to destination 330. Further, programming of computer 104 may schedule the charge interval during travel during the entire length of travel along highway 325. In such an example, computer 104 can actuate propulsion components 102 charge sensor battery 108B until the sensor battery attains a relatively high SOC and then deactivate charging after the SOC has been attained.

In another example, in response to planned destination 330 representing a destination at which a risk parameter exceeds a second threshold value, e.g., 0.07, 0.08, or any other value higher than the first threshold value, programming of computer 104 may determine or assign an upcoming interval for operation of sensor 108A that is comparatively long in duration, such as 24 hours, 36 hours, etc. Consequently, programming of computer 104 may distribute scheduled charge intervals to occur during any operation of engine 103, such as throughout one or more or even all travel segments of vehicle 102 on a route to a planned destination 330, which may include segments of stop-and-go traffic to intermediate destinations 315. In this context, “any” operation of engine 103 means a process performed by the engine as it converts fuel into heat or usable work capable of being transferred to a driveshaft of vehicle 102. In such an example, programming of computer 104 may place a premium on increasing or even maximizing the SOC of sensor battery 108B over conducting such charging operations during more efficient operation of engine 103. In such instances, an emphasis may be placed on protecting vehicle 102 from theft, vandalism, damage, break-in, or unauthorized removal of items from the vehicle over actuating sensor battery charging operations during more efficient operation of engine 103. Accordingly, sensors 108A may operate for an extended upcoming interval at planned destination 330.

In another example, programming of computer 104 may utilize a historical pattern of travel between current location 302 of vehicle 102 and planned destination 330. In such an example, in response to charging controller 108C indicating an SOC of sensor battery 108B that is insufficient to operate the sensor for an upcoming interval at planned destination 330, programming of computer 104 may utilize a historical pattern of travel to the planned destination to schedule charging (i.e. a charge interval) to occur during selected segments of vehicle travel. For example, a historical pattern of travel can be determined according to statistics such as a number of days of the week that a vehicle 102 typically travels to a destination and/or along a route, an average time of day that the vehicle 102 arrives at the destination, an average travel time along a route, etc. For example, in response to programming of computer 104 determining that vehicle 102 travels during weekdays to planned destination 330 at least a threshold number of days on average, e.g., at least a majority (three of five) of the weekdays, programming of computer 104 may schedule actuation of propulsion component 110A to charge sensor battery 108B until an interval during which the vehicle travels along highway 325. In another example, in response to programming of computer 104 determining that vehicle 102 travels to planned destination 330 on weekends, and in response to determining that a risk parameter at the destination is greater than a threshold, e.g., 0.05, 0.06, etc., the computer may actuate charging of sensor battery 108B during weekday travel. Accordingly, via such predictions performed via programming of computer 104, the computer may predict when upcoming sensor operations are likely to be utilized and then schedule charge intervals so as to provide sufficient SOC at planned destination 330.

In another example, programming of computer 104 may collect usage patterns of vehicle 102 for development of a usage model for future use. In this context, a “usage model” means a computer-implemented representation of a system (e.g., vehicle system 100) and/or a subsystem (e.g., security subsystem 108), which operates to predict future use of the system and/or subsystem based on prior usage of the system and/or the subsystem. Thus, for example, in response to vehicle 102 being utilized for daily travel between current location 302 and planned destination 330, programming of computer 104 may collect data indicating that sensors 108A have been operated for 1.0 hour each day during the previous month. Accordingly, computer 104 may form a usage model to predict usage of sensors 108A for one hour during each day of the ensuing month. Based on the usage model, programming of computer 104 can actuate propulsion component 110A during travel between current location 302 and planned destination 330 so as to maintain a sufficient SOC to operate sensors 108A for at 1.0 hours after deactivation of vehicle 102. In another example, in response to programming of computer 104 determining a variance from the mean interval of daily operation of sensors 108A, e.g., 1.0 hour±1.0 hour, over a period of several days, one week, one month, etc., the usage model implemented via programming of computer 104 may actuate propulsion component 110A to maintain a sufficient SOC to operate the sensors for a longer upcoming interval, such as for 2.0 hours after deactivation of vehicle 102. Thus, programming of computer 104 can control charging of sensor battery 108B so that sensors 108A are available for use during upcoming intervals without unwarranted excess charging of the sensor battery.

In an example, in response to deactivation of vehicle 102, programming of computer 104 can actuate HMI 112 to notify an operator of vehicle 102 of an upcoming interval during which sensors 108A are to remain active. Thus, for example, in response to an operator deactivating vehicle 102, display 305 of HMI 112 may notify an operator that sensors 108A are planned to be operated for a duration of 30 minutes, 1.0 hour, 2.0 hours, or another duration. Notification via HMI 112 can include an audio message, a visual message viewable by an operator, a text message to an operator's mobile device, etc.

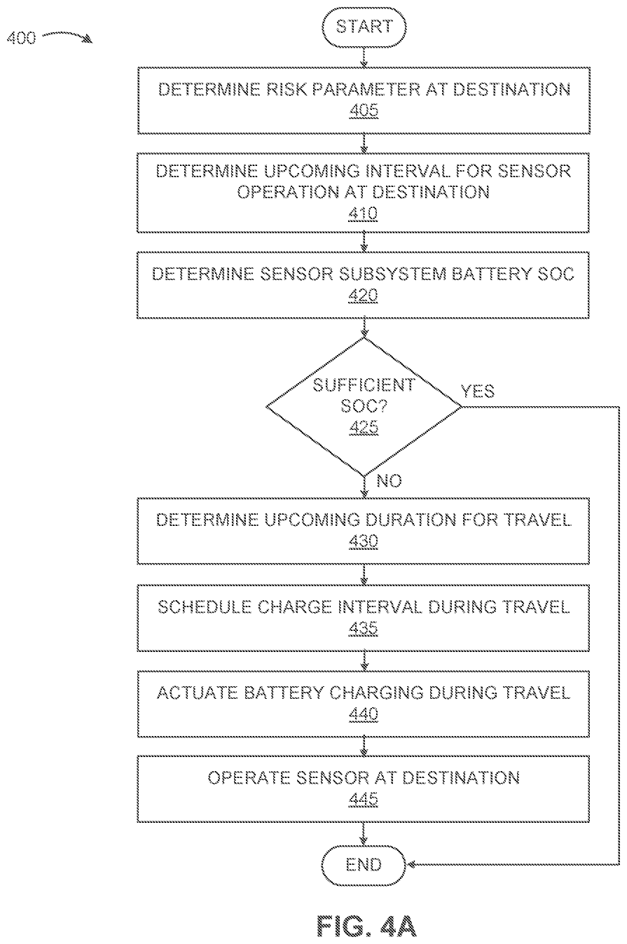

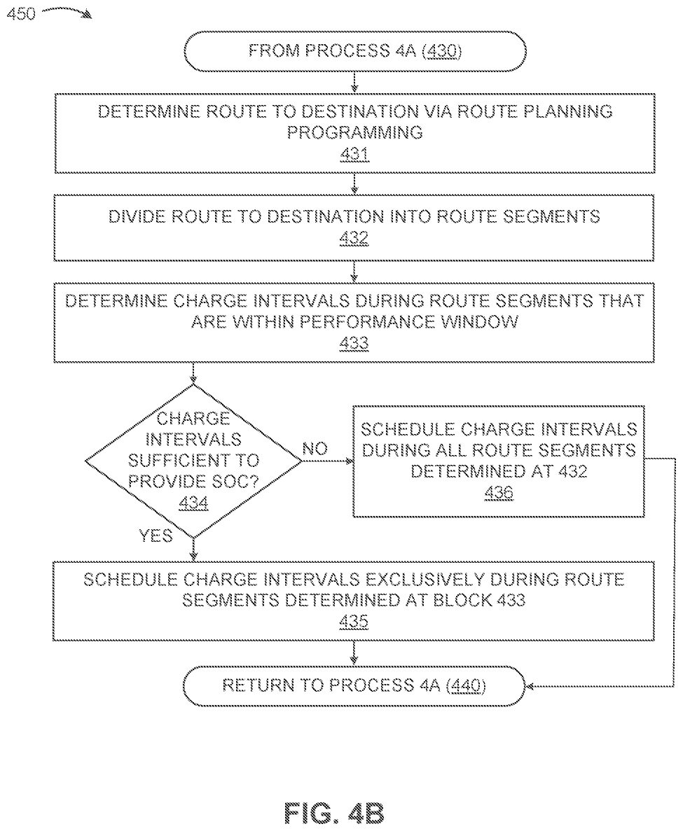

FIG. 4A is a block diagram of an example process 400 for powering sensors in a vehicle. In an example implementation, security subsystem 108 utilizes sensors 108A to view areas external to vehicle 102 after deactivation of the vehicle, e.g., at planned destination 330. An upcoming interval for operating sensors 108A can be based on a risk parameter of vehicle theft, damage, vehicle break-in, vandalism, and/or unauthorized removal of items from vehicle 102 at the planned destination. In response to a risk parameter being greater than a first threshold, e.g., 0.05, 0.06, etc., programming of computer 104 can actuate propulsion component 110A of vehicle 102 so as to provide sufficient charge to sensor battery 108B for operation of sensors 108A during a first upcoming interval. In response to a risk parameter being less than the first threshold, e.g., 0.01, 0.02, etc., programming of computer 104 can actuate propulsion component 110A of vehicle 102 so as to provide for operation of sensors during the second upcoming interval, which can be smaller than the first upcoming interval. Charging of sensor battery 108B can be conducted in response to engine 103 of vehicle 102 operating within a specified performance window of engine 103, such as performance window 205. A performance window may reflect a specified range of engine RPM, brake specific fuel consumption, brake mean effective pressure, etc.

Process 400 may begin at block 405, which may include determining a risk parameter at a planned destination, e.g., planned destination 330. Block 405 may include programming of computer 104 accessing a digital map that includes identifiers that assign a level of risk at planned destination 330 based on a rate of occurrence of vehicle break-ins, theft, vandalism, etc. In an example, at block 405, in response to a planned destination that involves parking on a particular city street, computer 104 may access a digital map to assign a relatively high risk parameter to a planned destination. In another example, block 405 may involve computer 104 assigning a relatively high risk parameter to any destination that involves city street parking. In another example, in response to a planned destination that involves parking in a secured monitored garage, computer 104 may access the digital map to assign a relatively low risk parameter to the planned destination.

A route to a planned destination can include various intermediate destinations, such as stops at convenience stores, gas stations, etc. A planned destination can include a risk parameter, which may indicate a measure of risk of damage to vehicle 102, theft of vehicle 102, etc. A risk parameter that is below a threshold, e.g., 0.01, 0.02, 0.03, may result from a planned destination that includes a locked garage at a private home, a secured commercial parking lot under video surveillance, etc. A risk parameter that is above a threshold, e.g., 0.05, 0.06, 0.07, may result from a planned destination that includes street parking, parking in an unlit parking area, etc.

Process 400 may continue at block 410, in which programming of computer 104 determines an upcoming interval for sensor operation based on the risk parameter determined at block 405. An upcoming interval can include a short, or even negligible, interval for sensor operation based on a risk parameter being lower than a first threshold. An upcoming interval can include a longer interval based on a risk parameter being greater than a first threshold, but less than a second threshold. An upcoming interval can include an extended interval based on a risk parameter being greater than a second threshold.

Process 400 may continue at block 420, which includes programming of computer 104 determining an SOC of sensor battery 108B based on, for example output data from charging controller 108C of security subsystem 108. In example process 400, programming of computer 104 may determine the upcoming interval of sensor operation based on the SOC of battery 108B. In an example, programming of computer 104 may utilize a power consumption model of security subsystem 108 that relates the SOC of battery 108B to an upcoming interval during which sensors 108A can be operated. Block 420 may additionally include programming of computer 104 utilizing historical travel patterns of vehicle 102, which may indicate additional vehicle travel durations when battery 108B can be charged prior to arriving at destination 330.

Process 400 may continue at block 425, which includes programming of computer 104 determining whether sensor battery 108B includes sufficient SOC to operate sensors 108A for the upcoming interval. In response to computer 104 determining that battery 108B includes sufficient SOC to operate sensors 108A for the upcoming interval, the process ends. In response to computer 104 determining that battery 108B includes insufficient SOC to operate sensors 108A for the upcoming interval, the process continues at block 430, else the process 400 ends.

Block 430 of process 400 includes programming of computer 104 determining an upcoming duration for travel to planned destination 330. Block 430 can include programming of computer 104 executing a suitable route planning technique, which may include computing an upcoming duration to travel to planned destination 330. A planned route may include intermediate destinations or waypoints, such as fuel stations, stores, etc., prior to reaching planned destination 330.

Process 400 may continue at block 435, which includes scheduling one or more charge intervals during travel to planned destination 330. At block 435, in response to computing an upcoming travel duration, computer 104 may divide a planned route to destination 330 into travel segments during which engine 103 of vehicle 102 may operate with threshold efficiency such as during travel along highway 325 (e.g., a highway segment). A threshold efficiency may correspond to engine 103 operating within a specified performance window, e.g., performance window 205. In response to computer 104 determining that sensor battery 108B cannot be sufficiently charged during operation of engine 103 that is within performance window 205, the computer may schedule charge intervals to occur at any segment of the planned route. Additional segments can include segments during which vehicle 102 is idling in traffic, proceeding slowly through stop-and-go traffic, etc.

Process 400 may continue at block 440, which may include actuating battery charging during travel. Actuation of battery charging during travel may include programming of computer 104 to instruct propulsion component 110A of vehicle 102 to actuate charging at specified segments of travel to destination 330. Thus, in an example, during vehicle travel, computer 104 may actuate propulsion component 110 to engage an alternator, or to actuate a control component of an alternator, to initiate current conduction from the alternator to sensor battery 108B.

Process 400 may continue at block 445, which may include an operator deactivating vehicle 102. Responsive to deactivation of vehicle 102, sensors 108A of security subsystem 108 may operate for the upcoming interval specified at block 410.

After block 445, process 400 ends.

FIG. 4B is a block diagram of an example process 450, which may operate as a subroutine of example process 400 executed at block 435. In example process 450, scheduling of a charge interval during travel of vehicle 102 involves determining a route to destination 330 and dividing the route into one or more route segments. Charge intervals can be scheduled during the route segments so as to distribute charge intervals among route segments during which engine 103 is to operate within performance window 205 described in reference to FIG. 2. In response to scheduled charge intervals resulting in insufficient charge of sensor battery 108B to operate sensors 108A determined at block 425, process 450 may schedule charge intervals to occur during additional route segments, such as route segments during which engine 103 is to operate outside of performance window 205.

Process 450 begins at block 431, which may occur after block 430 of process 400. Block 431 may include determining a route destination utilizing route planning programming of HMI 112. In an example, in response to an operator of vehicle 102 entering a street address of planned destination 330 via HMI 112, the HMI may access a navigation database or other memory to provide turn-by-turn directions for travel from current location 302 to planned destination 330.

Process 450 may continue at block 432, which includes programming of computer 104 aggregating the turn-by-turn instructions into route segments, such as stop-and-go segment 303 and highway segment 313. Computer 104 may classify a route segment as a stop-and-go segment based on whether the turn-by-turn directions from HMI 112 include stoplights, stop signs, etc. Computer 104 may classify a route segment as a highway segment based on whether the turn-by-turn directions exclude stoplights, stop signs, etc.

Process 450 may continue at block 433, at which computer 104 determines whether the route segments obtained at block 432 include route segments during which charge intervals are to occur. For example, in response to programming of computer 104 determining that the planned route of vehicle 102 includes highway segment 313, the computer may schedule a charge interval to occur while vehicle 102 travels along highway segment 313.

Process 450 may continue at block 434, at which programming of computer 104 determines whether travel along highway segment 313 can provide sufficient SOC for sensors 108A to operate during the upcoming interval determined at block 410. In response to computer 104 determining that travel along highway segment 313 can provide sufficient SOC for operation of sensors 108A, block 435 can be executed at which computer 104 can schedule a charge interval (e.g., charge interval 323) to occur exclusively during highway segment 313. As previously noted in regard to FIG. 2, during such highway travel, the speed and output torque of engine 103 of vehicle 102 may operate at ranges of brake mean effective pressure and speed that result in increased efficiency in charging sensor battery 108B.

In response to computer 104 determining at block 434 that travel along highway segment 313 will not provide sufficient SOC for operation of sensors 108A during the upcoming interval determined at block 410, block 436 may be executed. At block 436, programming of computer 104 may schedule charge intervals during all route segments determined at block 432. Thus, computer 104 may schedule charge intervals to occur during stop-and-go segment 303, highway segment 313, etc.

After completion of block 435 or block 436, process 450 ends and control is returned to block 440 of process 400.

Computing devices discussed herein, including the computer 104, include processors and memories, the memories generally each including instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Python, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in computer 104 is generally a collection of data stored on a computer readable medium, such as a storage medium, a random-access memory, etc.

A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It should further be understood that certain steps could be performed simultaneously, that other steps could be added, or that certain steps described herein could be omitted. For example, in process 400, one or more of the steps could be omitted, or the steps could be executed in a different order than shown in FIG. 4. In other words, the descriptions of systems and/or processes herein are provided for the purpose of illustrating certain embodiments and should in no way be construed so as to limit the disclosed subject matter.

Accordingly, it is to be understood that the present disclosure, including the above description and the accompanying figures and claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

Ordinal adjectives such as “first” and “second” are used throughout this document as identifiers and are not intended to signify importance or order.

What is claimed is:

1. A system comprising:
a computer including a processor coupled to a memory, the memory storing instructions executable by the processor to:
determine an upcoming interval for operating a sensor at a planned destination;
determine an upcoming duration for travel to the planned destination;
responsive to determining that a battery coupled to the sensor includes a state-of-charge (SOC) insufficient to operate the sensor for the upcoming interval, schedule a charge interval during vehicle travel to the planned destination; and
actuate the battery charging according to the scheduled charge interval during the vehicle travel.

2. The system of claim 1, wherein the upcoming interval is based on a risk parameter at the planned destination.

3. The system of claim 2, wherein the upcoming interval is increased based on the risk parameter at the planned destination being greater than a threshold value.

4. The system of claim 2, wherein the upcoming interval is decreased based on the risk parameter at the planned destination being less than a threshold value.

5. The system of claim 1, wherein the vehicle travel to the planned destination is segmented, and wherein the scheduled charge interval is distributed among the segments.

6. The system of claim 1, wherein the vehicle travel to the planned destination is segmented, and wherein the scheduled charge interval indicates battery charging exclusively at a segment during which an engine of the vehicle is predicted to operate with greater than a threshold efficiency.

7. The system of claim 1, wherein the instructions further include instructions to:
evaluate a historical pattern of vehicle travel between a current location of the vehicle and the planned destination to predict the SOC.

8. The system of claim 7, wherein the historical pattern of travel between the current location and the planned destination includes a time of day or during a day of the week.

9. The system of claim 1, wherein the instructions further include instructions to:
actuate a component of a human-machine interface responsive to deactivation of the vehicle at the planned destination, wherein the component indicates that the sensor is to be operated at the planned destination.

10. The system of claim 1, wherein the instructions further include instructions to:
actuate the battery charging operation responsive to an engine of the vehicle attaining greater than a threshold fuel efficiency.

11. The system of claim 1, wherein the instructions further include instructions to:
actuate the battery charging operation responsive to an engine of the vehicle attaining a brake specific fuel consumption that is less than a threshold value.

12. The system of claim 1, wherein the instructions to actuate the battery charging operation includes instructions to actuate the battery charging operation during any operation of an engine of the vehicle responsive to the determination that the battery charging operation is predicted to result in an insufficient SOC.

13. The system of claim 1, wherein the sensor includes a camera to view an area of an environment external to the system.

14. A method, comprising:
determining an upcoming interval for operating a sensor at a planned destination;
determining an upcoming duration for travel to the planned destination;
responsive to determining that a battery coupled to the sensor includes a state-of-charge (SOC) insufficient to operate the sensor for the upcoming interval, scheduling a charge interval during vehicle travel to the planned destination; and
actuating the battery charging according to the scheduled charge interval during the vehicle travel.

15. The method of claim 14, further comprising:
determining a risk parameter at the planned destination; and
determining the upcoming interval based on the risk parameter.

16. The method of claim 14, wherein the vehicle travel to the planned destination is divided into travel segments, and wherein the method further comprises:
distributing the scheduled charge interval among the travel segments.

17. The method of claim 14, further comprising:
determining a historical pattern of vehicle travel between a current location of the vehicle and the planned destination.

18. The method of claim 14, further comprising:
actuating the battery charging operation responsive to an engine of the vehicle attaining a brake specific fuel consumption that is less than a threshold value.

19. The method of claim 14, wherein the sensor is a camera to view an area of an environment external to the vehicle.

20. The method of claim 14, wherein actuating the battery charging operation includes actuating the battery charging operation during any operation of an engine of the vehicle responsive to the determining that the battery charging operation of the battery is predicted to result in an insufficient SOC.
